(19) United States
(12) Patent Application Publication
(10) Pub. No.: US 2003/0014643 A1
(43) Pub. Date: Jan. 16, 2003

(54) Electronic apparatus and debug authorization method

(75) Inventors: Tomomi Asami, Kawasaki (JP); Shigeru Hashimoto, Kawasaki (JP); Koken Yamamoto, Kawasaki (JP); Yoshiyasu Sugimura, Kawasaki (JP); Yusuke Kawasaki, Kawasaki (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: Fujitsu Limited

(21) Appl. No.: 10/105,188

(22) Filed: Mar. 26, 2002

(30) Foreign Application Priority Data
Jul. 12, 2001 (JP) 2001-374649

(51) Int. Cl. H04K 1/00

(52) U.S. Cl. 713/182

(57) ABSTRACT

An electronic apparatus is provided that can prevent wrongful reverse analysis by a third party. Authorization functions are provided in the electronic apparatus for judging whether or not to enable utilization of debugging functions. The authorization functions send command data to an external device connected to the electronic apparatus, based on a debug request containing the designation of a prescribed address range in the internal circuitry of the electronic apparatus, a first authorization is performed, based on the command data and on reply data to the command data received from the external device, a second authorization is performed, based on a user code received from the external device following the reply data, and use of the debugging functions is enabled, based on the first authorization and the second authorization.

### BACKGROUND OF THE INVENTION

1. Field of the Invention

This invention relates to an electronic apparatus having security functions for preventing wrongful acquisition of the behavior of internal circuitry in an electronic apparatus, and to an electronic apparatus debug authorization method.

There is a demand for highly secure equipment in all kinds of fields such as electronic commercial transactions. For that reason, methods have been devised for preventing the reverse analysis (reverse engineering) of apparatuses by all kinds of methods. Despite these efforts, there has been no end to cases of counterfeit ROMs and the like being produced and equipment being wrongfully used in applications not intended by the developers. For that reason, systems are demanded wherein the operations of the apparatuses themselves are impervious to reverse analysis by a third party.

2. Description of the Related Art

The CPU loaded into an IC (especially LSI) configuring part of the internal circuitry of an electronic apparatus has debugging functions (sometimes called a debug control unit or DCU below). When an apparatus that uses an LSI is being developed, the debugging functions acquire the behavior (content of program counter and registers and the like) of the internal circuitry (circuits other than memory and the like) comprising the LSI, monitor how the processing thereof is being done, inspect programs, and perform debugging. After product shipment, moreover, when a malfunction occurs or the apparatus is subjected to diagnostic testing, the debugging functions are similarly used. Conventionally, no security functions were provided against such debugging functions.

That being so, there is a problem in that a third party can easily perform accurate reverse analysis on the behavior of internal circuits (particularly LSIs) using the debugging functions, so that such apparatuses are defenseless in the security sense. For an electronic apparatus such as a POS register using a CPU having debugging functions, for example, by connecting the POS register (electronic apparatus) to a personal computer or the like (debugger), even data such as passwords or encryption keys or the like can easily be searched for and found.

### SUMMARY OF THE INVENTION

Accordingly, an object of the present invention is to provide an electronic apparatus, and an electronic apparatus debug authorization method, for preventing wrongful reverse analysis by a third party by providing security functions against the debugging functions.

An electronic apparatus is provided that can prevent wrongful reverse analysis by a third party. Authorization functions are provided in the electronic apparatus for judging whether or not to enable utilization of debugging functions. The authorization functions send command data to an external device connected to the electronic apparatus, based on a debug request containing the designation of a prescribed address range in the internal circuitry of the electronic apparatus, a first authorization is performed, based on the command data and on reply data to the command data received from the external device, a second authorization is performed, based on a user code received from the external device following the reply data, and use of the debugging functions is enabled, based on the first authorization and the second authorization.

### BRIEF DESCRIPTION OF THE DRAWINGS

FIG. 1 is a diagram of an example system configuration in an embodiment aspect of the present invention for debugging an electronic apparatus;

FIG. 2 is a flowchart of debug authorization function processing in an embodiment aspect of the present invention;

FIG. 3 is a flowchart of debug authorization function processing in an embodiment aspect of the present invention;

FIG. 4 is a diagram of an example system configuration in an embodiment aspect of the present invention that also comprises a signature making device;

FIG. 5 is a diagram for describing LSI 2 application examples;

FIG. 6 is a configuration diagram of LSI 2 peripheral circuitry; and

FIG. 7 is a diagram for describing an electronic apparatus.

### DESCRIPTION OF THE PREFERRED EMBODIMENTS

Embodiment aspects of the present invention are described below in conjunction with the drawings. However, the technological scope of the present invention is not limited by those embodiment aspects.

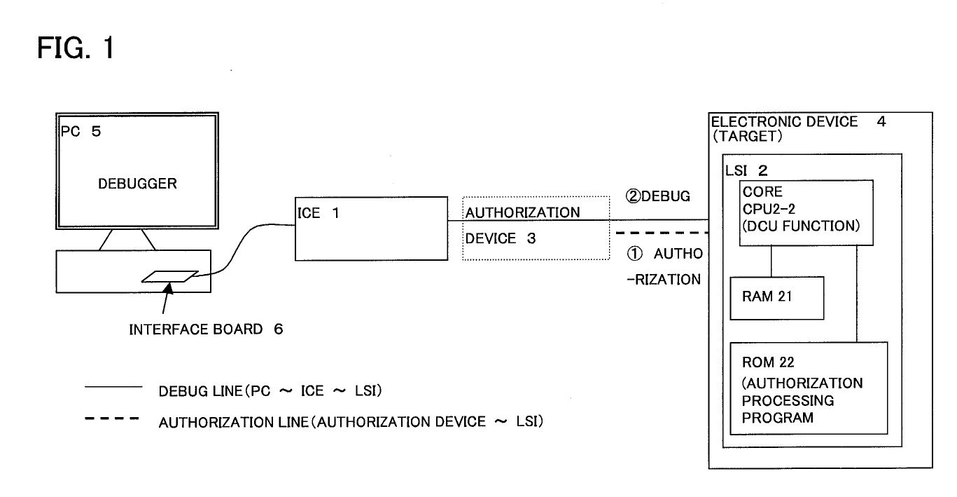

FIG. 1 is a diagram of an example system configuration in an embodiment aspect of the present invention for debugging an electronic apparatus. When debugging an electronic apparatus (target) wherein an IC (LSI, for example) 2 is mounted, an electronic apparatus 4 and an ICE (in circuit emulator) 1 are connected through an authorization device (external device) 3 that is characteristic of the present invention. The electronic apparatus 4 comprises internal circuits such as the LSI 2 which has a core CPU 2-2 which has debugging functions (DCU (debug control unit)), a RAM 21, ROM 22 and other peripheral circuitry. In the ROM 22 is loaded firmware (an authorization processing program) for effecting the security functions (debug authorization functions) that are characteristic of the present invention. The peripheral circuits differ according to the electronic apparatus 4 application, but an example is an electronic money settlement circuit. The electronic apparatus also comprises input means and display means (not shown) for designating address ranges in the internal circuitry that are to be debugged.

The authorization device 3 is inserted between the ICE 1 and the electronic apparatus 4, and performs authorization processing based on communications with the firmware in the LSI 2, as is described subsequently.

The ICE 1 also connects via an interface 6 to a general purpose personal computer (PC) 5 that is the debugger. The debugger, as will be described subsequently, can only use the debugging functions of the LSI 2 in the electronic apparatus when authorization processing has been performed correctly between the electronic apparatus 4 and the authorization device 3. That is, in order to enable the debugging functions of the LSI 2, it is necessary to have authorization processing performed between the authorization device 3 and the firmware in the electronic apparatus 4. When the authorization processing is not performed properly, the debugging functions of the LSI 2 will not operate, wherefore it is possible to prevent such wrongful acts as the reverse engineering of the internal behavior of an LSI by a third party after shipment of an electronic apparatus to the field, for example, so that higher security can be maintained.

Debug authorization function processing in an embodiment aspect of the present invention is now described.

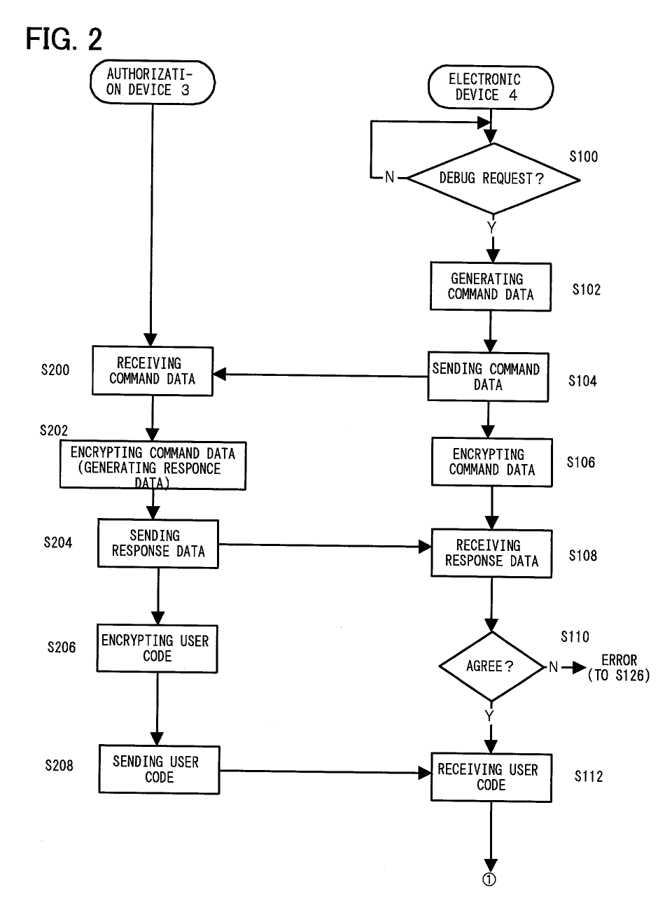

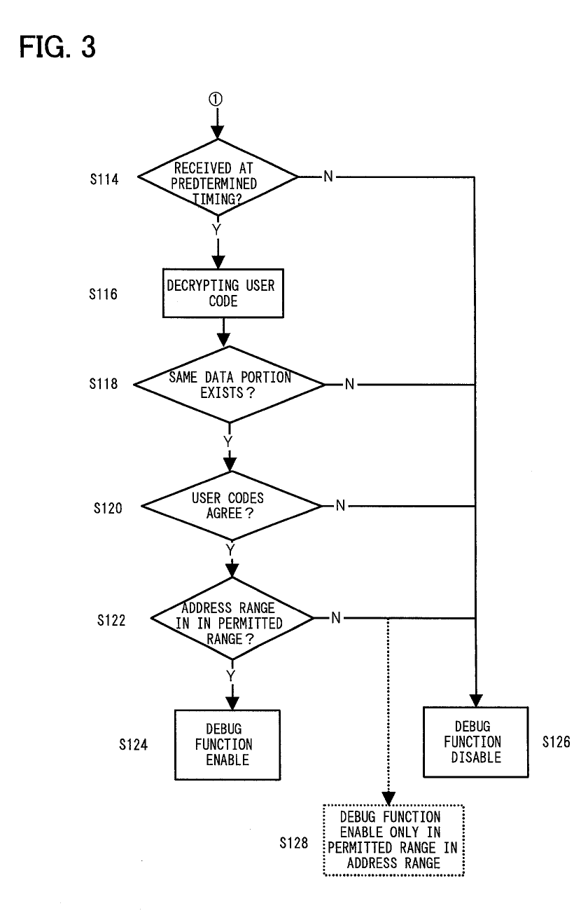

In FIGS. 2 and 3 are given flowcharts for debug authorization function processing in an embodiment aspect of the present invention. In the processing diagrammed in FIG. 2, firstly, after turning on the power to the electronic apparatus 4 and authorization device 3 and starting them up, a debug request is caused to be issued in the LSI 2 with an input operation or the like from the outside (S100). At this time, the address range to be debugged is also designated along with the debug request. When no address range is designated, it is assumed that all addresses are designated.

When a debug request is issued, following thereupon, command data are generated (S102), and the command data are sent to the authorization device 3 (S104). The command data are generated on the bases of random numbers, for example, and become different data for every debug request. The command data are encrypted using a prescribed encryption key in the LSI 2, thereby becoming encrypted data (S106).

Meanwhile, the authorization device 3, upon receiving the command data from the LSI 2 (S200), effects encryption using a prescribed encryption key (S202), and returns those encrypted data as reply data to the LSI 2 (S204).

The LSI 2, upon receiving the reply data from the authorization device 3 (S108), in a first authorization determination, compares the received reply data against the encrypted data (encrypted command data) generated in step S102 as noted above (S110). When those agree, the first authorization determination clears normally and transitions next to second authorization determination processing. If those do not agree, an error occurs (S126 in FIG. 3), and use of the debugging functions (DCU) is not allowed.

An official authorization device 3 will have the same encryption key as the encryption key of the electronic apparatus 4, and, when the authorization device 3 is an official device, the command data encrypted by the electronic apparatus 4 and the command data (reply data) encrypted by the authorization device 3 will agree.

The authorization device 3, after receiving the reply data in the LSI 2, also encrypts a user code stored in the authorization device 3 (S206), and, after prescribed timing, sends that encrypted user code to the LSI 2 (S208). The user code, which is registered in the authorization device 3 beforehand, contains identification information peculiar to a certain user, and a permission level corresponding to the address range which can be debugged in that user's LSI 2.

When an encrypted user code is received from the authorization device 3 (S112), the processing diagrammed in FIG. 3 is transitioned to, and, next, as the second authorization determination, a determination is made as to whether the timing of that reception is the prescribed timing (S114). The prescribed timing will be, for example, determined by a prescribed time (such as 5 clock signals, for example) elapsing after the timing of the reception of the reply data in step S108.

When reception has been made at the prescribed timing, the second authorization determination clears normally, and third authorization determination processing is next transitioned to. When that is not the case, an error occurs (S126), and use of the debugging functions (DCU) is not allowed. The official authorization device 3, after sending the reply data, sends the encrypted user data with prescribed timing.

After the second authorization determination processing, the encrypted user code received in step S112 is decrypted (S116), and, based on the user code obtained, the following third authorization determination processing, and, after that, fourth authorization determination processing and fifth authorization determination processing, are executed.

For the third authorization determination processing, a prescribed data portion of the command data (encrypted data) encrypted in step S106 and a prescribed data portion of the user code decrypted in step S116 are compared (S118). The user code has a data portion which is the same as the prescribed data portion of the data encrypted by the encryption key used as described earlier. To state that the other way around, the encryption key encrypts command data so as to have a data portion that is the same as one portion of the user code. When those agree, the third authorization determination clears normally, and the fourth authorization determination processing is transitioned to. When that is not the case, an error occurs (S126), and use of the debugging functions is not allowed.

By the first, second, and third authorization determination processing, it is determined whether or not the authorization device is an official device. That is, an official authorization device 3 will correctly encrypt command data from the LSI 2 (first authorization determination processing), send the encrypted user data with correct timing to the LSI 2 (second authorization determination processing), and then correctly encrypt the user data (third authorization determination processing). By determining whether or not the authorization device 3 is an official device by a plurality of authorization processes, in this manner, high security can be effected.

Following thereupon, as the fourth authorization determination processing, the user code decrypted in step S116 and the user code stored in a prescribed program in the electronic apparatus 4 are compared (S120). In the electronic apparatus 4, a user code is registered in a one-to-one correspondence with the user code in the authorization device 3. When those agree, the fourth authorization determination clears normally, and the fifth authorization determination processing is next transitioned to. When such is not the case, an error occurs (S126), and use of the debugging functions is not allowed.

By that fourth authorization determination processing, a determination can be made as to whether the user is an official user or not.

For the fifth authorization determination processing, furthermore, a determination is made as to whether or not the debugging range (address range) designated at the time of the debug request conforms to the permission level contained in the user code decrypted in step S116 (S122). When it does conform, the fifth authorization determination processing clears normally, and, therewith, it becomes possible to use the debugging functions of the CPU loaded in the LSI 2 for the designated address range (S124). When it does not conform (meaning both when the entire designated address range does not conform and when part of the designated address range does not conform), an error occurs, and use of the debugging functions is not allowed. Alternatively, provision may be made so that when part of the designated address range does not conform, use of the debugging functions is disallowed only in that range that does not conform (S128).

The firmware has a use allowance table wherein accessible ranges (debugging ranges) in an electronic apparatus are determined which correspond to a plurality of permission levels. The firmware references that use allowance table and determines whether or not a designated debugging range is contained within a debugging range corresponding to the permission level contained in the decrypted user code.

Thus, in this embodiment aspect, plural authorization processes ((plural) authorization device authorizations, user authorization, and debugging range authorization) are performed successively, and, unless all of those clear, the debugging functions cannot be used, wherefore high security can be guaranteed. Even with one of the plurality of authorization processes noted above, of course, comparatively high security can be guaranteed.

With a conventional security procedure using verification by a simple password or the like, moreover, if the password leaks out, the security procedure ceases to function properly, and the password is subject to being found out by repeated retrials. That being so, such a procedure is not well suited to a security mechanism for an electronic apparatus provided to multiple users. With this embodiment aspect, security is effected by the combination of the authorization device 3 and electronic apparatus 4 with firmware, so that authorization processing is performed by a physical connection and authorization algorithm, wherefore high security is made possible. Wrongful analysis by a personal computer (PC) 5 is also very difficult.

A user code that is signed in a prescribed program stored in memory in an electronic apparatus (target) may also be made variable. When the address range that can be debugged is to be altered, for example, the user code is changed in order to change the permission level contained in the user code. The permission level differs from user to user. For the user codes of ordinary users, for example, a comparatively low-level permission level having an address range (the LSI 2 itself, for example) that cannot be debugged is set, whereas, for the user codes of LSI developing manufacturer holders, a high-level permission level wherewith all address ranges (all address ranges in the target, inclusive of the LSI 2) can be debugged is set. That is because an LSI developing manufacturer holder needs to examine all of the address ranges when a problem arises or a device is subjected to diagnostic testing or the like.

However, when diagnostic testing or the like is being performed, and the maintenance person connects his or her authorization device, that is, an authorization device wherein the user code of the maintenance person is registered, to the electronic apparatus (target) on which diagnostics are being run, the user code of the authorization device (i.e. the user code of the maintenance person in this case) and the user code of the target (i.e. the user code of an ordinary user in this case) will not agree (and the permission level will also be different), wherefore, according to the processing diagrammed in FIG. 2, debugging cannot be done.

Thereupon, when the authorization device of the maintenance person is connected, and the target of an ordinary user is to be debugged, the user code of the target is changed beforehand to the user code of the maintenance person, and then the authorization device of the maintenance person is connected, whereupon debugging corresponding to the level information in the user code of the maintenance person becomes possible. The changing of the user code is performed by a signature making device connected to the PC 5, for example.

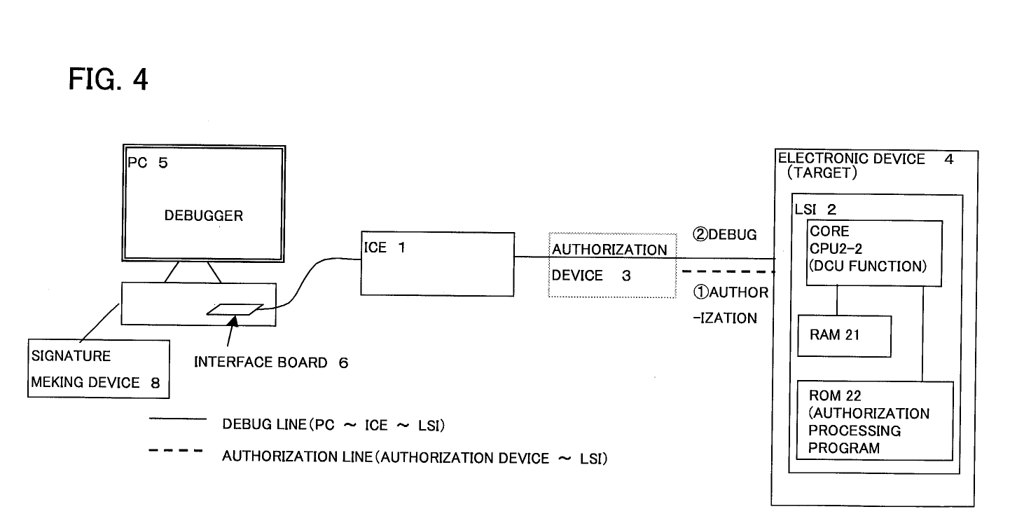

FIG. 4 is a diagram of an example system configuration in an embodiment aspect of the present invention that also comprises a signature making device. In FIG. 4, before a debug request is issued, a signature making device 8 extracts a signature containing a user code from a program stored in the electronic apparatus 4, through the PC 5, also produces a signature containing another user code (the user code of the maintenance person, for example), and, through the PC 5, rewrites the signature of that program in the electronic apparatus to that newly produced signature. Thus provision is made so that the signature is rewritten, the user code in the target is changed, and the permission level is also changed, so that, thereby, even ranges that cannot be debugged (or accessed) with the user code of an ordinary user can be debugged.

After debugging by the maintenance person has been completed, the signature in the electronic apparatus is restored to the signature of the ordinary user, using the signature making device 8.

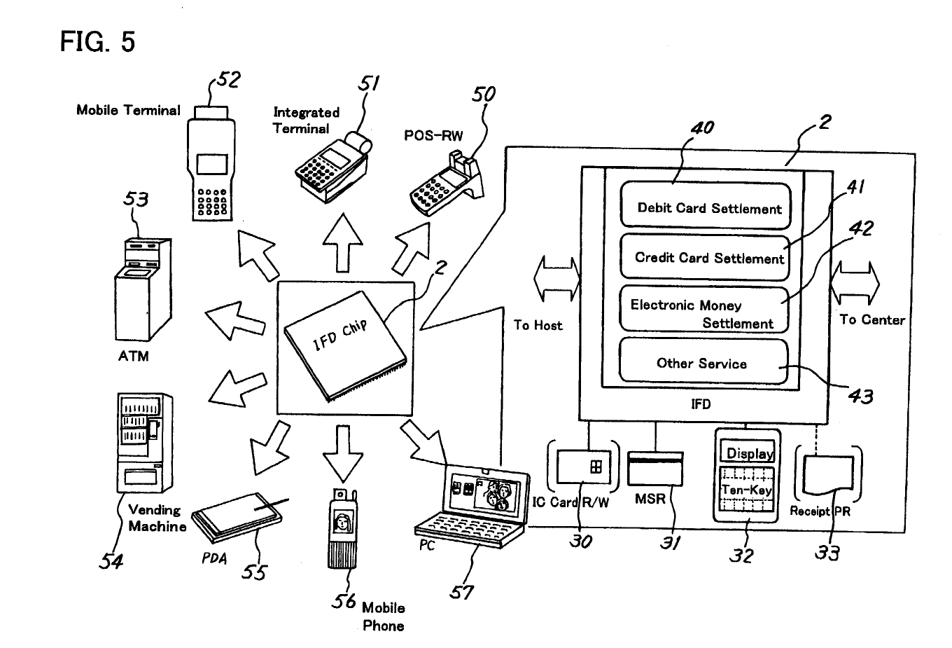

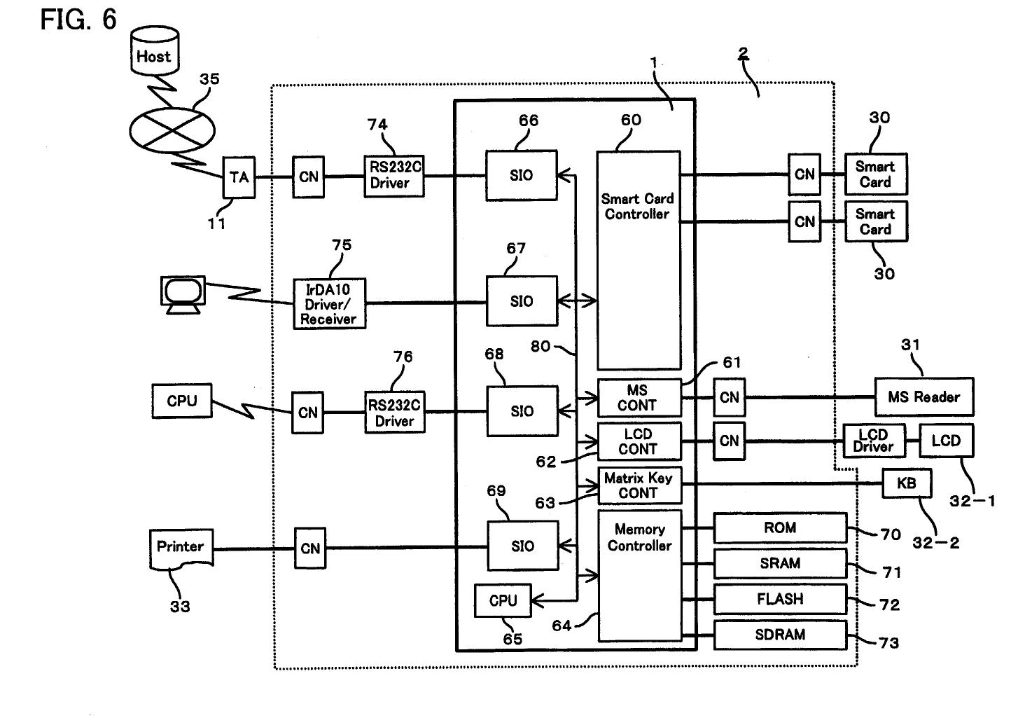

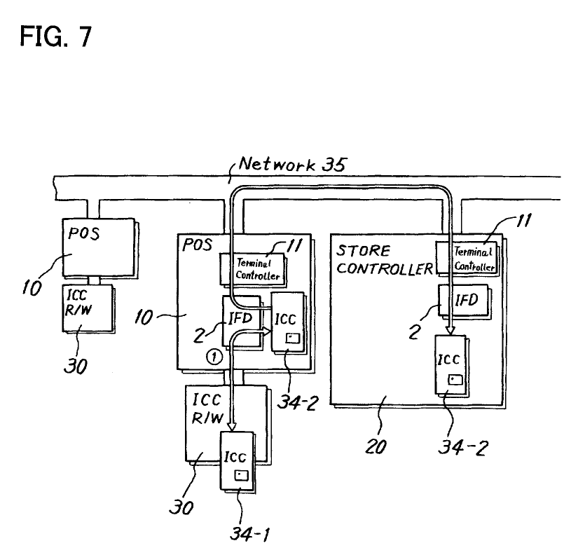

Next, an electronic apparatus (target) wherein is mounted the LSI 2 described earlier is described. FIG. 5 is an explanatory diagram for an application example of the LSI 2, FIG. 6 is a configuration diagram of peripheral circuitry for the LSI 2 in that application example, and FIG. 7 is an explanatory diagram of an electronic apparatus.

In the example diagrammed in FIG. 5, the LSI 2 is an LSI for card settlement having a debit card settlement function 40, credit card settlement function 41, electronic money settlement function 42, and other service function 43. Therefore, to the LSI 2 are connected an IC card reader/writer 30, magnetic card reader 31, an display and keypad 32. As necessary, moreover, a receipt printer 33 may also be connected. These settlement functions 40 to 43 are implemented by running a program in the CPU 2-2 of the LSI 2.

Accordingly, by mounting this LSI 2, card settlement functions can be imparted to the various electronic apparatuses 50 to 57. These electronic apparatuses are such, for example, as a POS reader/writer 50, general terminal 51, mobile terminal 52, ATM (automatic teller machine) 53, vending machine 54, PDA (personal data assistant) 55, portable telephone 56, or PC (personal computer) 57.

The peripheral circuitry for the LSI 2 for such card settlement is described with reference to FIG. 6. The peripheral circuitry has a smart card controller 60, an MS control circuit 61, an LCD control circuit 62, a matrix KB control circuit 63, a memory controller 64, and serial I/O boards 69 to 72. In FIG. 6, moreover, the LSI 2 described earlier is shown mounted on a target board 7.

The smart card controller 60 reads and writes data of the IC card (called a smart card) through the IC card reader/writer 30. The MS control circuit 61 controls the MS (magnetic stripe) reader 31. The LCD control circuit 62 controls the display of an LCD (liquid crystal display) 32-1. The matrix KB control circuit 63 recognizes inputs from the keypad 32-2. The memory controller 64 controls inputs and outputs to and from various memories (ROM 65, SRAM 66, FLASH memory 67, SDRAM 68) on the board 7. The serial I/O boards 69 to 72 are connected to drivers 73 to 75 on the board 7 for inputting and outputting serial data. These are all connected to a CPU bus.

FIG. 7 is a system configuration diagram for an electronic apparatus wherein a settlement LSI is mounted, representing a POS system. To a network 35 are connected a store controller 20 and a plurality of POS terminals 10. To each of the POS terminals 10 is connected an IC card reader/writer 30. To the store controller 20 and to the plurality of POS terminals 10 is connected the settlement LSI 2 (called an IFD) described earlier, and settlement data are sent and received directly. That is, the store controller 20 and POS terminals 10 comprise the electronic apparatus 4 in this embodiment aspect.

The IC card 34-1 of a customer communicates via the IFD 2 with a POS IC card 34-2, and the POS IC card 34-2 communicates with the IC card 34-2 of the store controller 20 via the IFD 2, terminal controller 11, network 35, terminal controller 11, and IFD 2.

When an electronic settlement is being done with an IC card, for example, data on the IC card 34-1 of the customer is sent via the IFD 2 and stored in the POS IC card 34-2. After that, data stored on the POS IC card 34-2 is sent via the IFD 2, terminal controller 11, network 35, terminal controller 11, and IFD 2, and stored in the IC card 34-2 in the store controller 20.

In this system, because the route of the electronic settlement data is closed by the IFDs 2, there is no danger of settlement data (i.e. passwords, account numbers, balances, and the like) leaking out, so security is high.

However, as described earlier, if the IFD 2 is accessed using debugging functions, settlement data (i.e. passwords, account numbers, balances, and the like) can be wrongfully acquired, and there is a danger of wrongful use. That being so, the debugging authorization functions of the present invention are particularly effective in applications like this.

In the embodiment aspect described in the foregoing, moreover, the LSI 2 is described for use in card settlements, but the invention can be used in other applications as well.

Based on the present invention, as described in the foregoing, security functions (debugging authorization functions) are provided for debugging functions for an electronic apparatus, wherefore wrongful acts such as the reverse engineering of the behavior of the internal circuitry of electronic apparatuses by a third party can be prevented, and higher security can be maintained than with conventional devices.

Because security is effected with the combination of an authorization device (external device) and firmware in an electronic apparatus, security is effected by a physical connection and an authorization algorithm, wherefore high security is made possible. Also, because a plurality of authorization processes is required, higher security can be guaranteed.

The scope of the protection of this invention is not limited to the embodiment aspect described above, but extends to inventions described in the claims and to what is equivalent thereto.

What is claimed is:

1. An electronic apparatus comprising:
internal circuitry comprising at least an LSI;
a debugging unit for debugging said internal circuitry; and
an authorization unit for enabling use of said debugging unit based on communications with an external device; wherein
said authorization unit sends command data to said external device based on a debug request containing designation of a prescribed address range in said internal circuitry, performs a first authorization based on the command data and on reply data to the command data received from said external device, performs a second authorization based on a user code received from said external device following said reply data, and enables use of said debugging unit based on said first authorization and said second authorization.

2. The electronic apparatus according to claim 1, wherein, in said first authorization, said authorization unit encrypts said command data and compares the encrypted command data and said reply data.

3. The electronic apparatus according to claim 1, wherein, in said second authorization, said authorization unit judges whether or not said user code was received at prescribed timing after receiving said reply data.

4. The electronic apparatus according to claim 1, wherein, in said second authorization, said authorization unit compares a data portion in said reply data and a data portion in said user code.

5. The electronic apparatus according to claim 1, wherein said internal circuitry stores in memory a user code registered beforehand, and, in said second authorization, said authorization unit compares a user code registered beforehand in said internal circuitry, and said received user code.

6. The electronic apparatus according to claim 1, wherein said debug request comprises a designated address range for said internal circuitry; said user code has information relating to an address range for said internal circuitry that can be debugged; and, in said second authorization, said authorization unit judges whether or not said designated address range at the time of said debug request is contained within said address range that can be debugged which corresponds to said received user code.

7. The electronic apparatus according to claim 1, wherein said user code is encrypted and sent by said external device, and said authorization unit decrypts the encrypted user code.

8. The electronic apparatus according to claim 5, wherein the user code registered in said internal circuitry is rewritable.

9. A debug authorization method for electronic apparatuses containing internal circuitry, comprising the steps of:
sending command data to an external device connected to said electronic apparatus based on a debug request containing designation of a prescribed address range in said internal circuitry;
performing a first authorization based on said command data and on reply data to the command data which are received from said external device;
performing a second authorization based on a user code received from said external device following said reply data; and
judging whether or not to enable debugging, based on said first authorization and said second authorization.

10. The debug authorization method according to claim 9, wherein said first authorization step includes encrypting said command data, and comparing the encrypted command data with said reply data.

11. The debug authorization method according to claim 9, wherein said second authorization step includes judging whether said user code was received at prescribed timing after reception of said reply data.

12. The debug authorization method according to claim 9, wherein said second authorization step includes comparing a data portion in said reply data and a data portion in said user code.

13. The debug authorization method according to claim 9, wherein said internal circuitry stores in memory a user code registered beforehand, and said second authorization step includes comparing the user code registered beforehand in said internal circuitry, and said received user code.

14. The debug authorization method according to claim 9, wherein said debug request comprises a designated address range for said internal circuitry; said user code has information relating to an address range for said internal circuitry that can be debugged; and said second authorization step includes judging whether or not said designated address range at the time of said debug request is contained within said address range that can be debugged which corresponds to said received user code.

15. An external device connected to an electronic apparatus, comprising:
an encryption unit for encrypting command data received from said electronic apparatus; and
a transmitter for sending command data encrypted by said encryption unit as reply data, and also sending user data registered beforehand at prescribed timing after sending said reply data.

16. The external device according to claim 15, wherein said user code is encrypted and sent by said encryption unit.
